(19) United States
(12) Patent Application Publication
(10) Pub. No.: US 2006/0186230 A1
(43) Pub. Date: Aug. 24, 2006

(54) Gaseous Fuel Injector for Linear Motor

(76) Inventor: Joseph S. Adams, Salt Spring Island (CA)

Correspondence Address: Stephen B. Salai, Esq.;Harter, Secrest & Emery LLP, 1600 Bausch & Lomb Place, Rochester, NY, 14604-2711, US

(21) Appl. No.: 11/307,627

(22) Filed: Feb. 15, 2006

Related U.S. Application Data
(60) Provisional application No. 60/593,880, filed on Feb. 22, 2005.

(51) Int. Cl. F02M 51/00

(52) U.S. Cl. 239/585.1

(57) ABSTRACT

An electromagnetically actuatable fuel injector for a linear engine includes a portioning chamber having inlet and outlet valves biased into closed positions and an armature is biased to open the inlet valve. An electromagnetic coil is energizable for moving the plunger in a direction out of engagement with the inlet valve and into engagement with the outlet valve for supplying a metered amount of fuel to the linear engine.

### FIELD OF THE INVENTION

An electrically activated gaseous fuel injection system includes an internal portioning chamber for dispensing metered amounts of gaseous fuel to a combustion chamber or mixing chamber of a linear engine as used in fastening tools, paintball launchers, or other prime mover devices that utilize a gaseous fuel such as propane, mapp, or propylene.

### DESCRIPTION OF RELATED ART

Fuel injection systems for linear engines such as may be used for driving fasteners include both liquid fuel metering and gaseous fuel metering. Typically, both types of fuel metering systems are arranged as fill-and-dump-type systems, which can be operated manually or in some cases automatically by internal pressures found in the engines during operation. However, external activation of these fill-and-dump injection systems can lead to fuel leakage issues arising from requirements for sliding seals or diaphragms to isolate a valving mechanism from an external actuating mechanism.

My U.S. Pat. No. 6,634,325 discloses a fuel injection system of the fill-and-dump type operated by way of pressure generated from a pumping action of an engine piston. A diaphragm converts the pumping pressure into linear motion for operating a three-way spool valve. In one valve position associated with increased pumping pressure, the spool is moved to a position that connects a plenum chamber with a pressurized supply of gaseous fuel. In another valve position associated with decreased pumping pressure, the spool is moved to a position that connects the plenum to an intake port of the linear engine. Separate valves can also be used to charge the plenum from a pressurized source of gaseous fuel and to discharge the plenum into the intake port of the linear engine.

Alternative metering systems, i.e., non-fill-and-dump-type systems for linear engines, typically include an electrically operated valve, which is held open for a controlled period of time to allow the proper amount of fuel to be delivered to the engine, as is common practice on most modern automotive gasoline engines. Gaseous fuel injection systems have tended to evolve in directions of greater complexity, which increases cost and requires finer control.

### SUMMARY OF INVENTION

A gaseous fuel injector in accordance with one or more embodiments of the invention meters gaseous fuel through a portioning chamber that alternately receives the gaseous fuel from a pressurized source and releases a predetermined volume of the gaseous fuel to an intake port of a linear engine. No external connections requiring seals are needed to operate the fuel injector. Instead, an electromagnetic actuator operating through an internal armature alternately opens and closes inlet and outlet valves of the fuel injector for discharging metered amounts of gaseous fuel into the linear engine. The armature can be housed within the portioning chamber and can be biased into a position at which the inlet valve is open and the outlet valve is closed. A magnetic field generated by the electromagnetic actuator can displace the armature into another position at which the inlet valve is closed and the outlet valve is open.

The gaseous fuel injector preferably regulates the passage of gaseous fuel from a source of pressurized fuel to the intake port of a linear engine through a closed conduit without any mechanical linkages through the conduit for opening or closing the inlet and outlet valves of the injector. Preferably, both the inlet valve and the outlet valve are individually biased into open or closed positions. However, the armature, which is preferably engageable with both valves, can be biased into a position at which the inlet valve is open and the outlet valve is closed. When energized, the electromagnetic actuator generates a magnetic field that overcomes the bias of the armature and moves the armature into another position at which the inlet valve is closed and the outlet valve is open for discharging the contents of the portioning chamber into the intake port of the engine.

One example of the invention as a gaseous fuel injector for a linear engine includes a portioning chamber, an inlet valve for regulating an admission of gaseous fuel into the portioning chamber, and an outlet valve for regulating a discharge of the gaseous fuel from the portioning chamber. Each of the inlet and outlet valves is biased toward one of an open and closed position. A field-sensitive plunger is movable within the portioning chamber in directions that alter the open and closed positions the inlet and outlet valves. The field-sensitive plunger is movable in a first direction at which the inlet valve is opened for admitting pressurized fuel into the portioning chamber, and the field-sensitive plunger is moveable in a second direction at which the outlet valve is opened for discharging the pressurized fuel from the portioning chamber.

Preferably the field-sensitive plunger can be biased in the first direction at which both the inlet valve is opened and the outlet valve is closed. The gaseous fuel injector preferably includes an electromagnetic actuator that is energizable for moving the field-sensitive plunger in the second direction at which both the outlet valve is opened and the inlet valve is closed. The sum of the forces acting in different directions for opening and closing the inlet and outlet valves include the biasing forces associated with each valve as well as a resultant of the bias force and the magnetic force imparted to the field-sensitive plunger.

The portioning chamber can be constructed with first and second ends. The inlet valve can be located at the first end of the portioning chamber, the outlet valve can be located at the second end of the portioning chamber, and the field-sensitive plunger can be translatable between positions of engagement with the inlet and outlet valves at the first and second ends of the portioning chamber. A first biasing force can be arranged to act between the first end of the portioning chamber and the inlet valve to bias the inlet valve toward a closed position. A second biasing force can be arranged to act between the second end of the portioning chamber and the outlet valve to bias the outlet valve toward a closed position. A third biasing force can be arranged to act between the portioning chamber and the field-sensitive plunger to bias the field-sensitive plunger in the first direction for opening the inlet valve and admitting pressurized fuel into the portioning chamber.

Alternatively, the first biasing force can be arranged to act between the field-sensitive plunger and the inlet valve to bias the inlet valve toward a closed position. The second biasing force can be arranged to act between the field-sensitive plunger and the outlet valve to bias the outlet valve toward a closed position. The third biasing force can be arranged to act between the portioning chamber and the field-sensitive plunger to bias the field-sensitive plunger in the first direction for opening the inlet valve and admitting pressurized fuel into the portioning chamber. Biasing forces can also be arranged to act between the inlet and outlet valves themselves to bias the inlet and outlet valves toward closed positions, while another biasing force acting between the portioning chamber and the field-sensitive plunger biases the field-sensitive plunger in the first direction for opening the inlet valve and admitting pressurized fuel into the portioning chamber.

The portioning chamber is preferably formed within a casing having an inlet regulated by the inlet valve, an outlet regulated by the outlet valve, and otherwise has uninterrupted walls for forming a closed conduit between the inlet and outlet. No mechanical linkages through the conduit are required for opening or closing the inlet or outlet valves of the injector.

Another example of the invention as an electromagnetically controlled gaseous fuel injector for a linear engine includes a portioning chamber having an inlet regulated by an inlet valve, an outlet regulated by an outlet valve, and an armature movable within the portioning chamber under the influence of an externally applied magnetic field. The armature together with the inlet and outlet valves is preferably biased into a position at which the inlet valve is open and the outlet valve is closed for charging the portioning chamber with a volume of gaseous fuel. The armature is movable from the biased position at which the inlet valve is open and the outlet valve is closed to an activated position at which the inlet valve is closed and the outlet valve is open for discharging the volume of gaseous fuel from the portioning chamber.

The portioning chamber is preferably formed within a fixed volume conduit between the inlet and outlet. Preferably, the armature is also movable through an intermediate position at which both the inlet and outlet valves are closed. In addition, the armature preferably engages the inlet valve through a range of open positions while the outlet valve remains closed, and the armature preferably engages the outlet valve through a range of open positions while the inlet valve remains closed.

Fluid volume exchanges with the portioning chamber are preferably limited to exchanges through the inlet and outlet of the portioning chamber. The portioning chamber is preferably formed within a casing, and the inlet and outlet are formed through walls of the casing, which are otherwise uninterrupted for forming a closed conduit between the inlet and outlet.

Biasing forces acting on the inlet and outlet valves can be directed between the portioning chamber and the inlet or outlet valves, between the armature and the inlet or outlet valves, or between the inlet and outlet valves themselves. A biasing force acting between the portioning chamber and the armature preferably biases the armature in a direction for opening the inlet valve and closing the outlet valve.

Yet another example of the invention as an in-line gaseous fuel injector for a linear engine includes a portioning chamber, an inlet valve at one end of the portioning chamber for connecting the portioning chamber to a pressurized fuel supply, and an outlet valve at another end of the portioning chamber for connecting the portioning chamber to the linear engine. The inlet and outlet valves are biased toward closed positions. However, an armature is moveable within the portioning chamber between positions of engagement with the inlet and outlet valves. The armature is biased into a first position at which the inlet valve is open and the outlet valve is closed for filling the portioning chamber with pressurized fuel. An electromagnetic coil is energizable for moving the armature into a second position at which the inlet valve is closed and the outlet valve is open for discharging the pressurized fuel into the engine.

Preferably, the armature engages the inlet valve through a range of open positions while the outlet valve remains closed and engages the outlet valve through a range of open positions while the inlet valve remains closed. Fluid volume exchanges with the portioning chamber are preferably limited to exchanges through the inlet and outlet of the portioning chamber. The portioning chamber can be formed within a casing, and the inlet and outlet are formed through walls of the casing, which are otherwise uninterrupted for forming a closed conduit between the inlet and the outlet.

### BRIEF DESCRIPTION OF THE DRAWING FIGURES

FIG. 1 is a diagram of an electromagnetically controlled gaseous fuel injection system of a linear engine.

FIGS. 2A-C are enlarged views of the gaseous fuel injector of FIG. 1 in three states of operation.

### DETAILED DESCRIPTION OF THE INVENTION

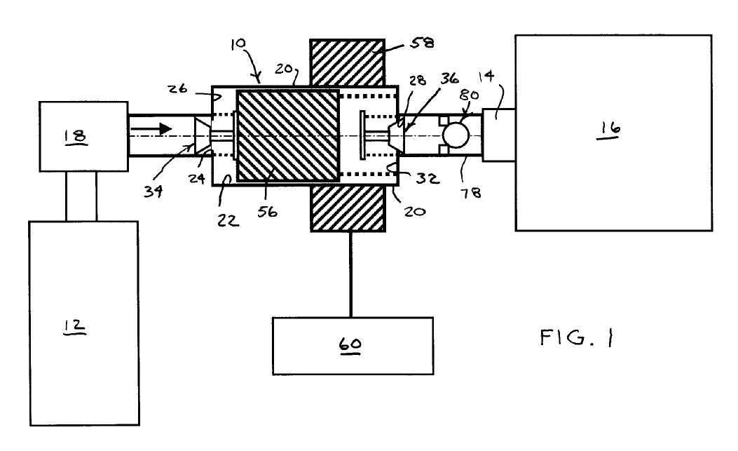

FIG. 1 depicts a gaseous fuel injection system featuring an inline gaseous fuel injector 10 for dispensing metered amounts of gaseous fuels such as propane, mapp, or propylene from a pressurized gaseous fuel supply 12 to an intake 14 of a linear engine 16. A regulator 18 interrupts the delivery of gaseous fuel to the fuel injector 10 for supplying the gaseous fuel to the fuel injector at a predetermined fluid pressure, such as 15 pounds per square inch.

The fuel injector 10 includes a casing 20 within which a portioning chamber 22 (i.e., plenum chamber) is formed having an inlet 24 at a first end 26 for admitting a predetermined volume of gaseous fuel into the portioning chamber 22 from the regulator 18 and an outlet 28 at a second end 32 for discharging the predetermined volume of gaseous fuel from the portioning chamber 22 into the intake 14 of the linear engine 16. An inlet valve 34 regulates the admission of gaseous fuel into the portioning chamber 22, and an outlet valve 36 regulates the discharge of gaseous fuel from the portioning chamber 22.

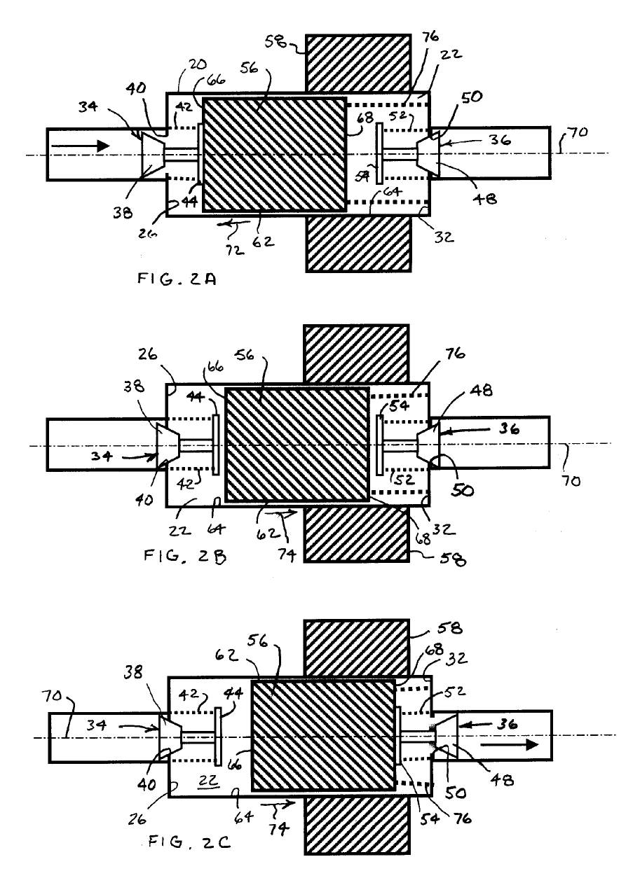

As more clearly seen in the enlarged views of FIGS. 2A-C, the inlet valve 34 includes a valve head 38 that is movable into and out of engagement with a valve seat 40. A compression spring 42 acting between the first end 26 of the portioning chamber 22 and a flange 44 carried by the valve head 38 stores energy for biasing the inlet valve 34 into a closed position at which the valve head 38 engages the valve seat 40 (see for example FIGS. 2B and 2C). Similarly, the outlet valve 36 includes a valve head 48 that is moveable into and out of engagement with a valve seat 50. A compression spring 52 acting between the second end 32 of the portioning chamber 22 and a flange 54 carried by the valve head 48 stores energy for biasing the outlet valve 36 into a closed position at which the valve head 48 engages the valve seat 50 (see for example FIGS. 2A and 2B).

A field-sensitive plunger 56, which is preferably made of a ferrous or magnetic material for functioning as an armature, is translatable along an axis 70 between the first and second ends 26 and 32 of the portioning chamber 22 under the influence of an electromagnetic actuator 58, preferably in the form of a solenoid coil, which surrounds the casing 20 of the fuel injector 10. Referring also to FIG. 1, an electrical source 60, such as a battery or other electrical power supply energizes the electromagnetic actuator 58 on demand. The field-sensitive plunger 56 is encapsulated within the portioning chamber 22 and is translated by magnetic lines of force generated by the surrounding electromagnetic actuator 58 without any linkages or other mechanical connections through the casing 20. Thus, the casing 20 forms a closed conduit between the inlet 26 and the outlet 28, which reduces possibilities for fuel leakage and component wear.

An exterior peripheral surface 62 of the field-sensitive plunger 52 is preferably matched with an interior peripheral surface 64 of the portioning chamber 22 to guide the translating motion of the plunger 56 along the axis 70. Various lands, rings, or other guide structures (not shown) common for directing the motion of armatures or other plungers can also be used. Gaps through or around the plunger 56 allow for maintaining even pressure throughout the portioning chamber 22 regardless of the position of the plunger 56 along the axis 70.

As shown in FIG. 2A, movement of the field-sensitive plunger 56 in a first direction 72 along the axis 70 moves a first end 66 of the plunger 56 into engagement with the flange 44 of the inlet valve 34 for displacing the valve head 38 from the valve seat 40 and opening the inlet valve 34. As shown in FIG. 2C, movement of the field-sensitive plunger 56 in a second direction 74 moves a second end 68 of the plunger 56 into engagement with the flange 54 of the outlet valve 36 for displacing the valve head 48 from the valve seat 50 and opening the outlet valve 36.

A main compression spring 76 acting between the second end 32 of the portioning chamber 22 and the second end 68 of the plunger 56 stores energy for biasing the plunger 56 in the first direction 72 into engagement with the inlet valve 34 for opening the inlet valve 34 and admitting pressurized fuel into the portioning chamber 22 as shown in FIG. 2A. In the plunger position depicted in FIG. 2A, the outlet valve 36, which is not in engagement with the plunger 56, remains closed under the biasing force exerted by its own compression spring 52. Thus, a finite volume of the portioning chamber 22 becomes charged with gaseous fuel at the pressure set by the regulator 18.

The electromagnetic actuator 58 is energizable by the electrical source 60 for producing a magnetic field that moves the field-sensitive plunger 52 in the second direction 74 along the axis 70. The accompanying magnetic force exerted on the plunger 52 is sufficient to overcome the biasing force of the main compression spring 76 and move the plunger 52 out of engagement with the inlet valve 34 and into engagement with the outlet valve 36. FIG. 2B depicts an intermediate position of the plunger 56 in which the plunger 56 is drawn by magnetic force in the second direction 74 out of engagement with the inlet valve 34 but has not yet reached an engagement with the outlet valve 36. Both the inlet valve 34 and the outlet valve 36 remain closed at the intermediate position of the plunger 56 under the biasing force of their respective compression springs 42 and 52.

Further movement of the plunger 56 in the second direction 74 under the influence of the electromagnetic actuator 58 moves a second end 68 of the plunger 56 into engagement with the flange 54 of the outlet valve 36 for displacing the valve head 48 from the valve seat 50 and opening the outlet valve 36 as shown in FIG. 2C. The inlet valve 34 remains closed. The pressurized fuel confined within the fixed volume of the portioning chamber 22 discharges through the outlet valve 36 into the intake 14 of the linear engine 16.

On some linear engines, the pressurized fuel is injected directly into a combustion chamber or into a premix chamber for mixing the charge of fuel with air before entering the combustion chamber. On other linear engines, as shown in FIG. 1, the pressurized fuel is injected into an intake tract 78 that delivers the fuel to the linear engine 16. A check valve 80 allows flows of pressurized fuel from the fuel injector 10 to the linear engine 16 but prevents backflows in the opposite direction. Fuel injections directly into premix chambers are preferred for certain applications such as for the combustion powered paintball marker disclosed in my copending U.S. application Ser. No. 10/760,922, which is hereby incorporated by reference.

When power to the electromagnetic actuator 58 is cut, the main spring 76 reverses the direction of force acting on the plunger 56 and moves the plunger 56 in the first direction 72 out of engagement with the outlet valve 36 for allowing the outlet valve 36 to close and back into engagement with the inlet valve 34 for reopening the inlet valve 34 as shown in FIG. 2A. At no time are the inlet and outlet valves 34 and 36 both open. Each one of the inlet and outlet valves 34 and 36 is progressively opened and progressively closed while the other of the inlet and outlet valves 36 or 34 remains closed. This feature allows for the accumulation and discharge of precise volumes of fuel through the fuel injector 10.

What is claimed is:

1. A gaseous fuel injector for a linear engine comprising
a portioning chamber,
an inlet valve for regulating an admission of gaseous fuel into the portioning chamber,
an outlet valve for regulating a discharge of gaseous fuel from the portioning chamber,
each of the inlet and outlet valves being biased toward one of an open and closed position,
a field-sensitive plunger being moveable within the portioning chamber in directions that alter the open and closed positions the inlet and outlet valves,
the field-sensitive plunger being movable in a first direction at which the inlet valve is opened for admitting pressurized fuel into the portioning chamber, and
the field-sensitive plunger being moveable in a second direction at which the outlet valve is opened for discharging the pressurized fuel from the portioning chamber.

2. The fuel injector of claim 1 further comprising an electromagnetic actuator that is energizable for moving the field-sensitive plunger in the second direction at which the outlet valve is opened.

3. The fuel injector of claim 2 in which the field-sensitive plunger is biased in the first direction at which the inlet valve is opened.

4. The fuel injector of claim 3 in which the electromagnetic coil is energizable for moving the field-sensitive plunger in the second direction at which both the outlet valve is opened and the inlet valve is closed.

5. The fuel injector of claim 4 in which the field-sensitive plunger is biased in the first direction at which both the inlet valve is opened and the outlet valve is closed.

6. The fuel injector of claim 1 in which the portioning chamber has first and second ends, the inlet valve is located at the first end of the portioning chamber, the outlet valve is located at the second end of the portioning chamber, and the field-sensitive plunger is translatable between positions of engagement with the inlet and outlet valves at the first and second ends of the portioning chamber.

7. The fuel injector of claim 6 in which a first biasing force acting between the first end of the portioning chamber and the inlet valve biases the inlet valve toward a closed position.

8. The fuel injector of claim 7 in which a second biasing force acting between the second end of the portioning chamber and the outlet valve biases the outlet valve toward a closed position.

9. The fuel injector of claim 8 in which a third biasing force acting between the portioning chamber and the field-sensitive plunger biases the field-sensitive plunger in the first direction for opening the inlet valve and admitting pressurized fuel into the portioning chamber.

10. The fuel injector of claim 1 in which a first biasing force acting between the field-sensitive plunger and the inlet valve biases the inlet valve toward a closed position.

11. The fuel injector of claim 10 in which a second biasing force acting between the field-sensitive plunger and the outlet valve biases the outlet valve toward a closed position.

12. The fuel injector of claim 11 in which a third biasing force acting between the portioning chamber and the field-sensitive plunger biases the field-sensitive plunger in the first direction for opening the inlet valve and admitting pressurized fuel into the portioning chamber.

13. The fuel injector of claim 1 in which biasing forces acting between the inlet and outlet valves bias the inlet and outlet valves toward closed positions.

14. The fuel injector of claim 13 in which a biasing force acting between the portioning chamber and the field-sensitive plunger biases the field-sensitive plunger in the first direction for opening the inlet valve and admitting pressurized fuel into the portioning chamber.

15. The fuel injector of claim 1 in which the inlet and outlet valves are biased toward closed positions and the field-sensitive plunger is biased in the first direction at which the inlet valve is opened for admitting pressurized fuel into the portioning chamber.

16. The fuel injector of claim 1 in which the portioning chamber is formed within a casing having an inlet regulated by the inlet valve, an outlet regulated by the outlet valve, and otherwise uninterrupted walls for forming a closed conduit between the inlet and outlet.

17. An electromagnetically controlled gaseous fuel injector for a linear engine comprising
a portioning chamber having an inlet regulated by an inlet valve and outlet regulated by an outlet valve,
an armature movable within the portioning chamber under the influence of an externally applied field,
the armature together with the inlet and outlet valves being biased into positions at which the inlet valve is open and the outlet valve is closed for charging the portioning chamber with a volume of gaseous fuel, and
the armature being movable from the biased position at which the inlet valve is open and the outlet valve is closed to an activated position at which the inlet valve is closed and the outlet valve is open for discharging the volume of gaseous fuel from the portioning chamber.

18. The fuel injector of claim 17 in which the armature is movable through an intermediate position at which both the inlet and outlet valves are closed.

19. The fuel injector of claim 17 in which the armature is engageable with the inlet valve through a range of open positions while the outlet valve remains closed.

20. The fuel injector of claim 19 in which the armature is engageable with the outlet valve through a range of open positions while the inlet valve remains closed.

21. The fuel injector of claim 17 in which fluid volume exchanges with the portioning chamber are limited to exchanges through the inlet and outlet of the portioning chamber.

22. The fuel injector of claim 21 in which the portioning chamber is formed within a casing and the inlet and outlet are formed through walls of the casing which are otherwise uninterrupted for forming a closed conduit between the inlet and outlet.

23. The fuel injector of claim 17 in which a biasing force acting between the portioning chamber and the inlet valve biases the inlet valve toward one of an open and a closed position, and another biasing force acting between the portioning chamber and the outlet valve biases the outlet valve toward one of an open and a closed position.

24. The fuel injector of claim 17 in which a biasing force acting between the armature and the inlet valve biases the inlet valve toward one of an open and a closed position, and another biasing force acting between the armature and the outlet valve biases the outlet valve toward one of an open and a closed position.

25. The fuel injector of claim 17 in which biasing forces acting between the inlet and outlet valves bias the inlet and outlet valves valve toward one of an open and a closed position.

26. The fuel injector of claim 17 in which a biasing force acting between the portioning chamber and the armature biases the armature in a direction for opening the inlet valve and closing the outlet valve.

27. The fuel injector of claim 17 in which a sum of forces for opening and closing the inlet and outlet valves includes biasing forces associated with each of the inlet and outlet valves as well as a resultant of a bias force and a magnetic force imparted to the armature.

28. The fuel injector of claim 17 regulates the portioning chamber provides a passage for gaseous fuel from the inlet to the outlet through a closed conduit without any mechanical linkages through the conduit for opening or closing the inlet and outlet valves.

29. An in-line gaseous fuel injector for a linear engine comprising
a portioning chamber,
an inlet valve at one end of the portioning chamber for connecting the portioning chamber to a pressurized fuel supply,
an outlet valve at another end of the portioning chamber for connecting the portioning chamber to the linear engine,
the inlet and outlet valves being biased toward closed positions,
an armature moveable within the portioning chamber between positions of engagement with the inlet and outlet valves,
the armature being biased into a first position at which the inlet valve is open and the outlet valve is closed for filling the portioning chamber with pressurized fuel, and
an electromagnetic actuator being energizable for moving the armature into a second position at which the inlet valve is closed and the outlet valve is open for discharging the pressurized fuel into the engine.

30. The fuel injector of claim 29 in which the armature is engageable with the inlet valve through a range of open positions while the outlet valve remains closed.

31. The fuel injector of claim 30 in which the armature is engageable with the outlet valve through a range of open positions while the inlet valve remains closed.

32. The fuel injector of claim 29 in which fluid volume exchanges with the portioning chamber are limited to exchanges through the inlet and outlet of the portioning chamber.

33. The fuel injector of claim 32 in which the portioning chamber is formed within a casing and the inlet and outlet are formed through walls of the casing which are otherwise uninterrupted for forming a closed conduit between the inlet and the outlet.

34. The fuel injector of claim 29 further comprising a check valve located along an engine intake track to prevent backflows to the outlet valve.
